(19) United States
(12) Patent Application Publication
(10) Pub. No.: US 2007/0029915 A1
(43) Pub. Date: Feb. 8, 2007

(54) Light-generating unit, display device having the same, and method of driving the same

(76) Inventors: Jae-Kwang Kim, Seoul (KR); Kyu-Seok Kim, Yongin-si (KR)

Correspondence Address: CANTOR COLBURN, LLP, 55 GRIFFIN ROAD SOUTH, BLOOMFIELD, CT, 06002, US

(21) Appl. No.: 11/498,516

(22) Filed: Aug. 3, 2006

(30) Foreign Application Priority Data
Aug. 4, 2005 (KR) 2005-71308

(51) Int. Cl. H01J 1/62

(52) U.S. Cl. 313/483

(57) ABSTRACT

A light-generating unit includes at least one light source group and a power supply module. The light source group includes a plurality of light sources each emitting a light of a different color from each other and each having a different effective light-emitting area from each other, so as to generate a white light including a mixture of lights emitted from the light sources. The power supply module applies one driving voltage to the light sources. Thus, a white light having a desired wavelength distribution may be generated while one driving voltage is applied to the light sources of the light-generating unit.

This application claims priority to Korean Patent Application No. 2005-71308, filed on Aug. 4, 2005 and all the benefits accruing therefrom under 35 U.S.C. §119, and the contents of which in its entirety are herein incorporated by reference.

### BACKGROUND OF THE INVENTION

1. Field of the Invention

The present invention relates to a light-generating unit, a display device having the light-generating unit, and a method of driving the light-generating unit. More particularly, the present invention relates to a light-generating unit capable of being simply driven, a display device having the light-generating unit, and a method of driving the light-generating unit.

2. Description of the Related Art

Generally, a liquid crystal display (“LCD”) device displays images using electrical and optical characteristics of liquid crystal within the LCD device. The LCD device has various advantages, for example, thin thickness, small volume, and light weight structure in comparison with a cathode ray tube (“CRT”) device. Thus, the LCD device has been widely used for portable computers, communication devices, television sets, etc.

The LCD device includes a liquid crystal control unit that controls liquid crystal, and a light-providing unit that provides light to the liquid crystal. For example, the LCD device includes an LCD panel serving as the liquid crystal control unit and a backlight assembly serving as the light-providing unit.

For example, the backlight assembly includes a light source that generates light and a light-guiding plate that guides the light from the light source and provides planar light to the LCD panel. Examples of the light source include a cold cathode fluorescent lamp (“CCFL”) having a cylindrical shape, and a light-emitting diode (“LED”) having a dot shape. The LED is usually employed in the LCD device having a relatively small display area, such as a mobile communication device, so as to reduce volume and power consumption of the LCD device.

A conventional small or medium sized LCD device usually employs a white LED. However, the white LED has a weak peak wavelength at both a green color area and a red color area, and thus reproducibility of green color and reproducibility of red color are insufficient.

In order to overcome the above problems, an optical spectrum of light from the white LED may be somewhat improved. However, currently, since a yellow fluorescent material is coated on a blue LED to form the white LED, it is difficult to change the optical spectrum of the light from the white LED. Thus, instead of changing the optical spectrum of the light from the white LED, an RGB LED including red, green and blue chips may be advantageously used.

In a conventional RGB LED, different voltages are applied to the red, green and blue chips to control an electric current in each of the red, green and blue chips, thereby generating white light.

However, a red light, a green light and a blue light generated from the red, green and blue chips, respectively, have different brightness with respect to each other, and thus different voltages are applied to the red, green and blue chips to generate a white light having a desired wavelength distribution. Therefore, a circuit for driving the conventional RGB LED is complicated.

### BRIEF SUMMARY OF THE INVENTION

The present invention obviates the above problems, and thus the present invention provides a light-generating unit that is capable of being simply driven.

The present invention also provides a display device having the above-mentioned light-generating unit.

The present invention also provides a method of driving the above-mentioned light-generating unit.

In exemplary embodiments of the present invention, a light-generating unit includes a light source group and a power supply module. The light source group includes a plurality of light sources each emitting a light of a different color from each other and each having a different effective light-emitting area from each other, so as to generate a white light including a mixture of lights emitted from the light sources. The power supply module applies one driving voltage to the light sources.

The red, green and blue light sources may include a red light-emitting diode (“LED”), a green LED and a blue LED, respectively. An effective light-emitting area of the blue LED may be greater than an effective light-emitting area of the green LED, and the effective light-emitting area of the green LED may be greater than an effective light emitting area of the red LED.

The power supply module may include a circuit board having a driving voltage applying line providing the driving voltage to the light sources and a power supply device applying the driving voltage to the light sources through the driving voltage applying line formed on the circuit board.

The light sources may be electrically connected to each other in series or in parallel, and a ratio of the effective light-emitting areas may correspond to a luminous intensity ratio of the lights generated from the light sources.

In other exemplary embodiments of the present invention, a light-generating unit includes a first light source, a second light source, and a third light source. The first light source emits a first light and has a first effective light-emitting area. The second light source emits a second light and has a second effective light-emitting area. The third light source emits a third light and has a third effective light-emitting area. The first, second, and third effective light-emitting areas are different from each other such that the first, second and third lights are mixed to generate a white light.

For example, the first, second, and third light sources include a red LED, a green LED and a blue LED, respectively.

The light-generating unit may further include a power supply module driving the first, second, and third light sources. The power supply module applies one driving voltage to the first, second and third light sources.

In still other exemplary embodiments of the present invention, a display device includes a light-generating unit and a display panel. The light-generating unit includes a light source group and a power supply module. The light source group includes a plurality of light sources each emitting a light of a different color from each other and each having a different effective light-emitting area from each other, so as to generate a white light including a mixture of lights emitted from the light sources. The power supply module applies one driving voltage to the light sources. The display panel displays an image using the light generated from the light-generating unit.

The display device optionally includes a light-guiding plate disposed at a side of the light-generating unit to guide an optical path of the white light generated from the light-generating unit to the display panel. In an alternative embodiment, the display device optionally includes a light-guiding member disposed on or over the light-generating unit to mix the lights generated from the light-generating unit so as to provide the white light to the display panel.

In still other exemplary embodiments of the present invention, a display device includes a light-generating unit and a display panel. The light-generating unit includes a first light source emitting a first light and having a first effective light-emitting area, a second light source emitting a second light and having a second effective light-emitting area, and a third light source emitting a third light and having a third effective light-emitting area. The first, second and third effective light-emitting areas are different from each other such that the first, second and third lights are mixed to generate a white light. The display panel displays an image using the light generated from the light-generating unit.

In yet other exemplary embodiments of the present invention, a method of driving a light-generating unit having a light source group including first, second, and third light sources each emitting a light of a different color from each other to generate a white light in combination includes supplying a first driving voltage to the first light source having a first effective light-emitting area, supplying the first driving voltage to the second light source having a second effective light-emitting area different than the first effective light-emitting area, and supplying the first driving voltage to the third light source having a third effective light-emitting area different than the first and second effective light-emitting areas.

According to the above, a red light source, a green light source, and a blue light source of the light-generating unit have different effective light-emitting areas from each other, thereby generating a white light having a desired wavelength distribution while one driving voltage is applied to the red, green, and blue light sources.

### BRIEF DESCRIPTION OF THE DRAWINGS

The above and other features and advantages of the present invention will become more apparent by describing exemplary embodiments thereof with reference to the accompanying drawings, in which:

FIG. 1 is a perspective view illustrating an exemplary light-generating unit according to a first exemplary embodiment of the present invention;

FIG. 2 is a cross-sectional view taken along line I-I′ in FIG. 1;

FIG. 3 is a circuit diagram illustrating driving a conventional light-generating unit including light-emitting diodes (“LEDs”) having substantially the same effective light-emitting areas;

FIG. 4 is a circuit diagram illustrating driving the exemplary light-generating unit illustrated in FIG. 1;

FIG. 5 is a circuit diagram illustrating driving an exemplary light-generating unit according to a second exemplary embodiment of the present invention;

FIG. 6 is a plan view illustrating an exemplary light-generating unit according to a third exemplary embodiment of the present invention;

FIG. 7 is a schematic view illustrating driving a conventional light-generating unit including LEDs having substantially the same effective light-emitting areas;

FIG. 8 is a schematic view illustrating driving the exemplary light-generating unit illustrated in FIG. 6;

FIG. 9 is a schematic view illustrating driving an exemplary light-generating unit according to a fourth exemplary embodiment of the present invention;

FIG. 10 is an exploded perspective view illustrating an exemplary liquid crystal display (“LCD”) device according to a fifth exemplary embodiment of the present invention; and

FIG. 11 is an exploded perspective view illustrating an exemplary LCD device according to a sixth exemplary embodiment of the present invention.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the sizes and relative sizes of layers and regions may be exaggerated for clarity.

It will be understood that when a member or layer is referred to as being “on,” “connected to” or “coupled to” another member or layer, it can be directly on, connected or coupled to the other member or layer or intervening members or layers may be present. In contrast, when a member is referred to as being “directly on,” “directly connected to” or “directly coupled to” another member or layer, there are no intervening members or layers present. Like numbers refer to like members throughout. As used herein, the term “and/or” includes any and all combinations of one or more of the associated listed items.

It will be understood that, although the terms first, second, etc. may be used herein to describe various members, components, regions, layers and/or sections, these members, components, regions, layers and/or sections should not be limited by these terms. These terms are only used to distinguish one member, component, region, layer or section from another member, component, region, layer or section. Thus, a first member, component, region, layer or section discussed below could be termed a second member, component, region, layer or section without departing from the teachings of the present invention.

Spatially relative terms, such as “beneath,” “below,” “lower,” “above,” “upper” and the like, may be used herein for ease of description to describe one member or feature's relationship to another member(s) or feature(s) as illustrated in the figures. It will be understood that the spatially relative terms are intended to encompass different orientations of the device in use or operation in addition to the orientation depicted in the figures. For example, if the device in the figures is turned over, members described as “below” or “beneath” other members or features would then be oriented “above” the other members or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, members, and/or components, but do not preclude the presence or addition of one or more other features, integers, steps, operations, members, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Now, exemplary embodiments of the present invention will be described with reference to the accompanying drawings.

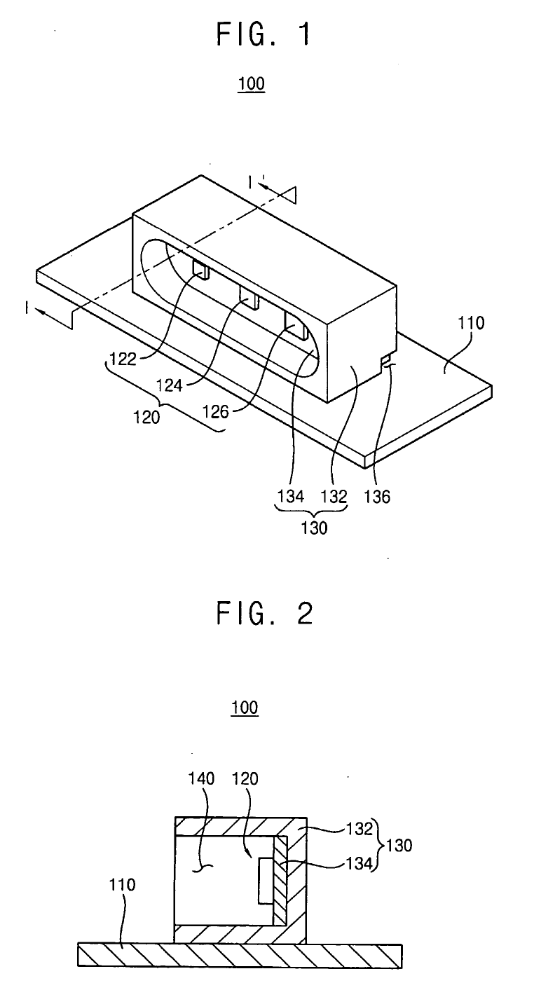

FIG. 1 is a perspective view illustrating an exemplary light-generating unit according to a first exemplary embodiment of the present invention. FIG. 2 is a cross-sectional view taken along line I-I′ in FIG. 1.

Referring to FIGS. 1 and 2, a light-generating unit 100 includes a circuit board 110, a light source group 120, and a housing 130.

The circuit board 110 includes a circuit pattern to apply a driving voltage to the light source group 120. Particularly, a driving voltage applying line (not shown) is formed on the circuit board 110 to apply the driving voltage to the light source group 120. The circuit board 110 and a power supply device (not shown) that applies the driving voltage to the light source group 120 through the driving voltage applying line form a power supply module.

The light source group 120 includes a plurality of light sources. The light sources receive the driving voltage from the power supply device through the circuit pattern of the circuit board 110, and thus each of the light sources within the light source group 120 generates a monochromatic light different from each other. For example, the light source group 120 includes a red light source generating a red light having a red wavelength, a green light source generating a green light having a green wavelength, and a blue light source generating a blue light having a blue wavelength.

For example, the red light source generates a light having a wavelength of greater than or equal to about 630 nm, the green light source generates a light having a wavelength of about 500 nm to about 630 nm, and the blue light source generates a light having a wavelength of less than or equal to about 465 nm.

In FIGS. 1 and 2, the red, green, and blue light sources include a red light-emitting diode (“LED”) 122, a green LED 124, and a blue LED 126, respectively. The red, green, and blue LEDs 122, 124 and 126 may each have a chip shape. The red, green, and blue LEDs 122, 124 and 126 may have differently-sized first, second, and third effective light-emitting areas, as will be further described below.

The housing 130 receives the light source group 120. The housing 130 includes a body 132 and a sub-circuit board 134.

The body 132 has, for example, a substantially rectangular parallelepiped shape, a side of which is open, although alternate shapes of the body 132 would also be within the scope of these embodiments. A receiving space 140 for receiving the red, green, and blue LEDs 122, 124 and 126 of the light source group 120 is formed in the open side of the body 132.

The red, green, and blue LEDs 122, 124 and 126 are formed on the sub-circuit board 134. The sub-circuit board 134 is disposed in the receiving space 140 to transmit the driving voltage from the power supply module to the red, green, and blue LEDs 122, 124 and 126. In the illustrated embodiment, the sub-circuit board 134 is positioned to be substantially perpendicular with respect to the circuit board 110, although alternate positions are within the scope of these embodiments. The red, green, and blue LEDs 122, 124, and 126 are positioned on a side of the sub-circuit board 134 facing an opening of the body 132.

The red, green, and blue LEDs 122, 124 and 126 may be electrically connected to an electrode (not shown) patterned on the sub-circuit board 134. The red, green, and blue LEDs 122, 124, and 126 may be also electrically connected to each other. A bonding wire may serve as a connecting member that electrically connects the red, green, and blue LEDs 122, 124 and 126 to each other. The bonding wire may include, by example only, gold (Au).

Optionally, a cutout 136 is formed through an edge portion of a rear surface of the body 132, adjacent a side opposite to an opening of the body 132. The electrode of the sub-circuit board 134 may be electrically connected to the circuit board 110 for driving the red, green, and blue LEDs 122, 124 and 126 through the cutout 136. A circuit structure will be further described below.

A protective layer (not shown) may be formed on the red, green, and blue LEDs 122, 124 and 126 to fill in the receiving space 140. The protective layer includes, for example, diffused epoxy resin. Thus, the protective layer may isolate the red, green, and blue LEDs 122, 124 and 126 from the exterior and protect the light source group 120 disposed in the receiving space 140. In addition, the protective layer may mix and diffuse the red light, the green light, and the blue light emitted from the red, green, and blue LEDs 122, 124 and 126, respectively, so as to generate a white light.

FIG. 3 is a circuit diagram illustrating driving a conventional light-generating unit including LEDs having substantially the same effective light-emitting areas.

Referring to FIG. 3, a conventional light-generating unit 10 includes a light source group 20. The light source group 20 includes red, green, and blue LEDs 22, 24 and 26. The red, green and blue LEDs 22, 24 and 26 each have substantially the same effective light-emitting areas. The effective light-emitting area indicates an emitting area from which light is substantially emitted.

Different driving voltages are applied to the red, green, and blue LEDs 22, 24 and 26 corresponding to a luminous intensity ratio of the red light, the green light, and the blue light to generate a white light having a desired wavelength distribution.

As shown in FIG. 3, different driving voltages V_{R}, V_{G}, and V_{B} are applied to the red, green, and blue LEDs 22, 24 and 26, respectively. For example, the driving voltages V_{R}, V_{G}, and V_{B} are about 1.95 V to 2.2 V, about 2.8 V to 3.7 V, and about 3.4 V to 3.9 V, respectively. As a result, the conventional light-generating unit 10 generates a white light having a desired wavelength distribution but requiring the different driving voltages V_{R}, V_{G}, and V_{B}.

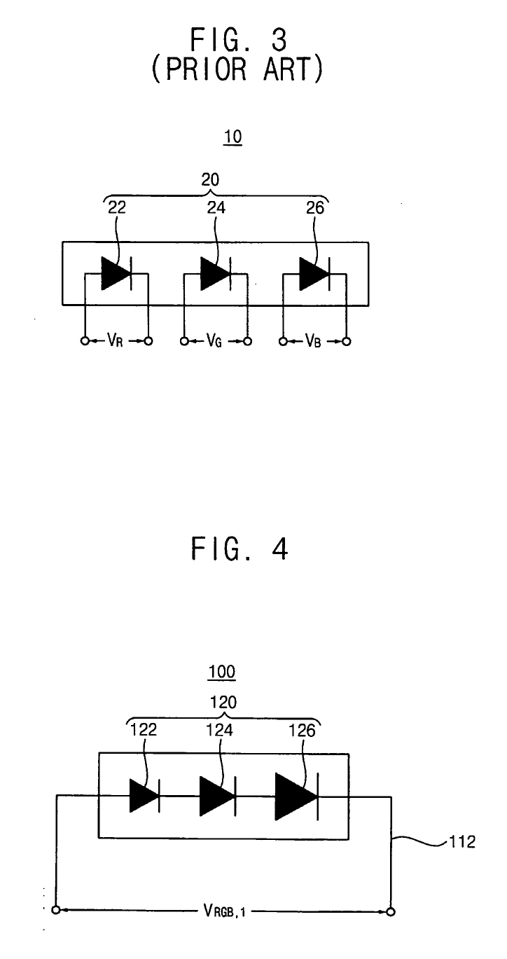

FIG. 4 is a circuit diagram illustrating driving the exemplary light-generating unit illustrated in FIG. 1.

Referring to FIG. 4, the red, green, and blue LEDs 122, 124 and 126 are electrically connected to a driving voltage applying line 112 formed on the circuit board 110 shown in FIG. 1.

A driving voltage V_{RGB,1} is applied from the power supply device to the red, green, and blue LEDs 122, 124 and 126 through the driving voltage applying line 112. The red, green, and blue LEDs 122, 124 and 126 each receive the same driving voltage V_{RGB,1}, to thereby generate the red, green, and blue lights, respectively.

Generally, when a light-emitting area of an LED increases or decreases, a luminous intensity of light emitted from the LED also increases or decreases as a voltage applied to the LED increases or decreases. Thus, when the voltage applied to the LED is changed, substantially the same luminous intensity may be obtained by also changing the light-emitting area of the LED.

Red, green, and blue LEDs 22, 24 and 26 of the conventional light-generating unit 10 shown in FIG. 3 have substantially the same effective light-emitting areas. In contrast, the red, green, and blue LEDs 122, 124 and 126 of the light-generating unit 100 according to exemplary embodiments of the present invention have different-sized first, second, and third effective light-emitting areas, respectively, so as to correspond to a luminous intensity ratio of the red, green, and blue lights forming a white light having a desired wavelength distribution.

Accordingly, even though only one driving voltage V_{RGB,1} is applied to the red, green, and blue LEDs 122, 124 and 126, the first, second, and third effective light-emitting areas compensate for reduced luminous intensities, to thereby obtain a desired white light.

The red, green and blue lights emitted from the red, green, and blue LEDs 122, 124 and 126, respectively, forms a white light using a predetermined combination of the luminous intensities of the red, green, and blue LEDs 122, 124 and 126. Hence, the first, second, and third effective light-emitting areas may be determined corresponding to the luminous intensity ratio of red, green, and blue lights forming a white light having a desired wavelength distribution. Thus, sizes of the red, green and blue LEDs 122, 124 and 126 may be determined corresponding to the first, second, and third effective light-emitting areas.

For example, in order to obtain a white light having substantially the same wavelength distribution as a predetermined wavelength distribution of a white light generated by applying driving voltages of about 2.1 V, about 3.3 V, and about 3.7 V to red, green, and blue LEDs, respectively, the first, second and third light-emitting areas of the red, green, and blue LEDs 122, 124 and 126 may be determined as follows.

In one exemplary embodiment, the red, green, and blue LEDs 122, 124 and 126 are electrically connected to each other in series, and a driving voltage V_{RGB,1} is applied to the red, green, and blue LEDs 122, 124 and 126. Substantially the same current flows in each of the red, green, and blue LEDs 122, 124 and 126. The driving voltage V_{RGB,1} is, for example, about 3.7 V.

Voltages applied to the red, green, and blue LEDs 122, 124 and 126 may be different from each other in accordance with various intrinsic properties such as material. However, when the voltages are substantially the same, the first, second and third light-emitting areas may be set to about 2.1: about 3.3: about 3.7. In other words, the light-emitting area of the red LED 122 may be smaller than the light-emitting area of the green LED 124, and the light-emitting area of the green LED 124 may be smaller than the light-emitting area of the blue LED 126. When the voltages are different from each other, such as due to the various intrinsic properties such as material, the first, second, and third light-emitting areas may be adjusted to obtain a desired white light.

According to the present embodiment, the first, second, and third effective light-emitting areas of the red, green, and blue LEDs 122, 124 and 126 are set different from each other, so that a white light having a desired wavelength distribution may be obtained while one driving voltage is applied to the red, green, and blue LEDs 122, 124 and 126.

The light-generating unit 100 according to the present embodiment includes the housing 130 as shown in FIGS. 1 and 2, and thus may be packaged. Thus, the light-generating unit 100 may serve as a light source of an edge illumination type liquid crystal display (“LCD”) device. However, the light-generating unit 100 is not limited to the light source of an edge illumination type LCD device, and alternate applications of the light-generating unit 100 would also be within the scope of these embodiments.

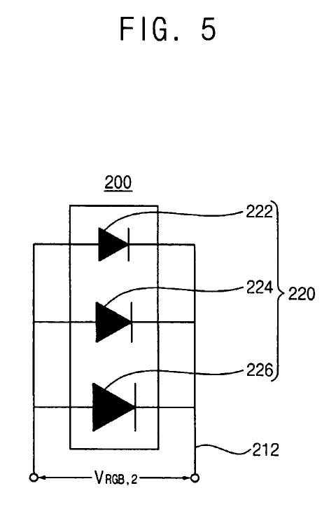

FIG. 5 is a circuit diagram illustrating driving an exemplary light-generating unit according to a second exemplary embodiment of the present invention.

Referring to FIG. 5, a light-generating unit 200 includes a light source group 220 having red, green, and blue LEDs 222, 224 and 226.

The light-generating unit 200 of FIG. 5 is substantially the same as the light-generating unit 100 of the previously described embodiment except for electrical connections between the red, green, and blue LEDs 222, 224 and 226 that are electrically connected in parallel. Thus, any further description will be omitted.

The red, green, and blue LEDs 222, 224 and 226 are electrically connected to a driving voltage applying line 212 formed on a circuit board, such as the circuit board 110 shown in FIG. 1.

A driving voltage V_{RGB,2} is applied from a power supply device to the red, green, and blue LEDs 222, 224 and 226 through the driving voltage applying line 212. The red, green, and blue LEDs 222, 224 and 226 receive the driving voltage V_{RGB,2}, to thereby generate red, green and blue lights, respectively.

In the exemplary embodiment shown in FIG. 5, the red, green, and blue LEDs 222, 224 and 226 are electrically connected in parallel, and only one driving voltage V_{RGB,2} is applied to the red, green, and blue LEDs 222, 224 and 226. Thus, substantially the same voltage V_{RGB,2} is applied to each of the red, green, and blue LEDs 222, 224 and 226.

For example, in order to obtain a white light having substantially the same wavelength distribution as a predetermined wavelength distribution of a white light generated by applying driving voltages of about 2.1 V, about 3.3 V, and about 3.7 V to red, green, and blue LEDs, respectively, and since substantially the same voltage V_{RGB,2} is applied to each of the red, green, and blue LEDs 222, 224 and 226, first, second, and third light-emitting areas of the red, green and blue LEDs 222, 224 and 226 may be set to about 2.1: about 3.3: about 3.7, to thereby obtain a desired white light. In other words, the light-emitting area of the red LED 222 may be smaller than the light-emitting area of the green LED 224, and the light-emitting area of the green LED 224 may be smaller than the light-emitting area of the blue LED 226.

Thus, according to the second embodiment, the first, second, and third effective light-emitting areas of the red, green and blue LEDs 222, 224 and 226 are set different from each other, so that a white light having a desired wavelength distribution may be obtained while a same, or substantially a same, driving voltage is applied to the red, green, and blue LEDs 222, 224 and 226.

In addition, since the red, green, and blue LEDs 222, 224 and 226 of the light-generating unit 200 are electrically connected to each other in parallel, driving voltages applied to the red, green, and blue LEDs 222, 224 and 226 are substantially the same. Thus, when the effective light-emitting areas are determined, an additional adjustment of a ratio of the effective light-emitting areas may be omitted. The additional adjustment may be necessary when different driving voltages are applied to the red, green, and blue LEDs 222, 224 and 226.

The light-generating unit 200 may include a housing, such as housing 130 shown in FIG. 1, and thus may be packaged. Thus, the light-generating unit 200 may serve as a light source of an edge illumination type LCD device. However, the light-generating unit 200 is not limited to the light source of an edge illumination type LCD device, and other applications of the light-generating unit 200 would be within the scope of these embodiments.

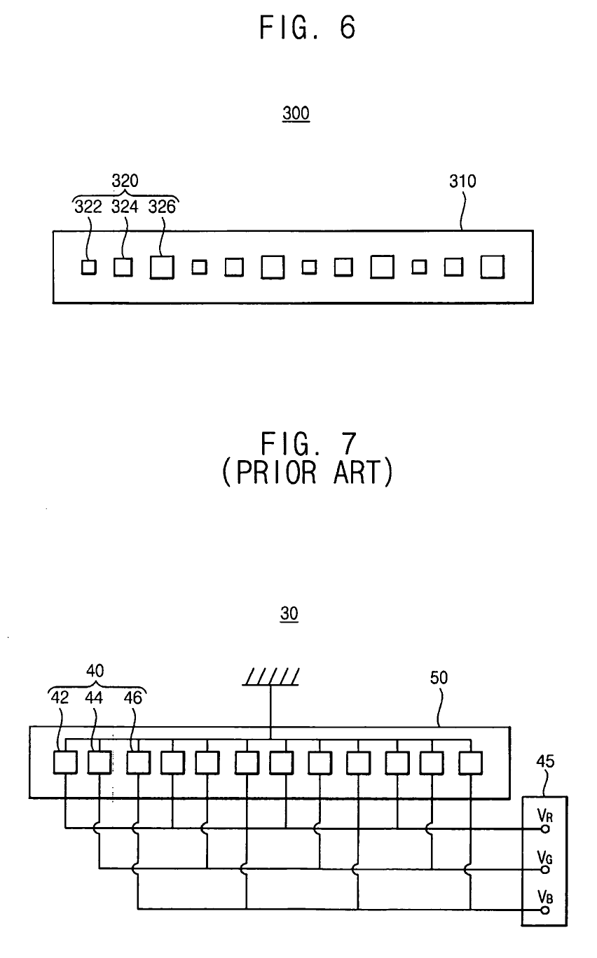

FIG. 6 is a plan view illustrating an exemplary light-generating unit according to a third exemplary embodiment of the present invention.

Referring to FIG. 6, a light-generating unit 300 includes a circuit board 310 and a light source group 320, or a plurality of light source groups 320.

The circuit board 310 includes a circuit pattern (not shown) to apply a driving voltage to the light source group 320. Particularly, a driving voltage applying line (not shown) is formed on the circuit board 310 to apply the driving voltage to the light source group 320. The circuit board 310 and a power supply device (not shown) that applies the driving voltage to the light source group 320 through the driving voltage applying line form a power supply module.

The light source group 320 includes a plurality of light sources. The light sources receive the driving voltage through the circuit pattern of the circuit board 310, and thus each light source generates a monochromatic light different from each other. For example, the light source group 320 includes a red light source generating a red light having a red wavelength, a green light source generating a green light having a green wavelength, and a blue light source generating a blue light having a blue wavelength.

The red light source generates a light having a wavelength of greater than or equal to about 630 nm, the green light source generates a light having a wavelength of about 500 nm to about 630 nm, and the blue light source generates a light having a wavelength of less than or equal to about 465 nm.

In FIG. 6, the red, green and blue light sources include a red LED 322, a green LED 324, and a blue LED 326, respectively. The red, green, and blue LEDs 322, 324 and 326 may each have a chip shape.

In FIG. 6, the red, green, and blue LEDs 322, 324 and 326 are disposed in a line. Alternatively, the red, green, and blue LEDs 322, 324 and 326 may be disposed forming various shapes, such as a substantially triangular shape. When a plurality of the light source groups 320 are mounted on the circuit board 310 as shown, the red, green, and blue LEDs 322, 324, and 326 may be sequentially arranged in a repeated pattern as shown, or may otherwise be alternatively arranged.

The red, green, and blue LEDs 322, 324 and 326 are formed on the circuit board 310. The red, green and blue LEDs 322, 324 and 326 may be electrically connected to an electrode (not shown) patterned on the circuit board 310. The red, green, and blue LEDs 322, 324 and 326 may be also electrically connected to each other. A bonding wire may serve as a connecting member that electrically connects the red, green, and blue LEDs 322, 324 and 326 to each other. The bonding wire may include, for example, gold (Au).

The red, green, and blue LEDs 322, 324 and 326 may each include a lens. Each lens diffuses lights emitted from the red, green, and blue LEDs 322, 324 and 326, respectively, to thereby increase effective light-emitting areas of the red, green, and blue LEDs 322, 324 and 326.

As illustrated in FIG. 6, the light-generating unit 300 includes a plurality of light source groups 320, and the light source groups 320 are disposed on the circuit board 310 in a single line. Alternatively, the light source groups 320 may be disposed on the circuit board 310 to form a plurality of lines.

FIG. 7 is a schematic view illustrating driving a conventional light-generating unit including LEDs having substantially the same effective light-emitting areas.

Referring to FIG. 7, a conventional light-generating unit 30 includes a light source group 40, or a plurality of light source groups 40. The light source group 40 includes red, green, and blue LEDs 42, 44 and 46 mounted on a circuit board 50. The red, green, and blue LEDs 42, 44 and 46 each have substantially the same effective light-emitting areas.

Different driving voltages from a power supply device 45 are applied to the red, green, and blue LEDs 42, 44 and 46 so as to correspond to a luminous intensity ratio of a red light, a green light, and a blue light forming a white light having a desired wavelength distribution.

As shown in FIG. 7, different driving voltages V_{R}, V_{G} and V_{B} are applied from the power supply device 45 to the red, green and blue LEDs 42, 44 and 46. For example, the driving voltages V_{R}, V_{G} and V_{B} are about 1.95 V to 2.2 V, about 2.8 V to 3.7 V, and about 3.4 V to 3.9 V, respectively. As a result, the conventional light-generating unit 30 generates a white light having a desired wavelength distribution, but requires a complicated circuit to apply the different driving voltages to each of the LEDs.

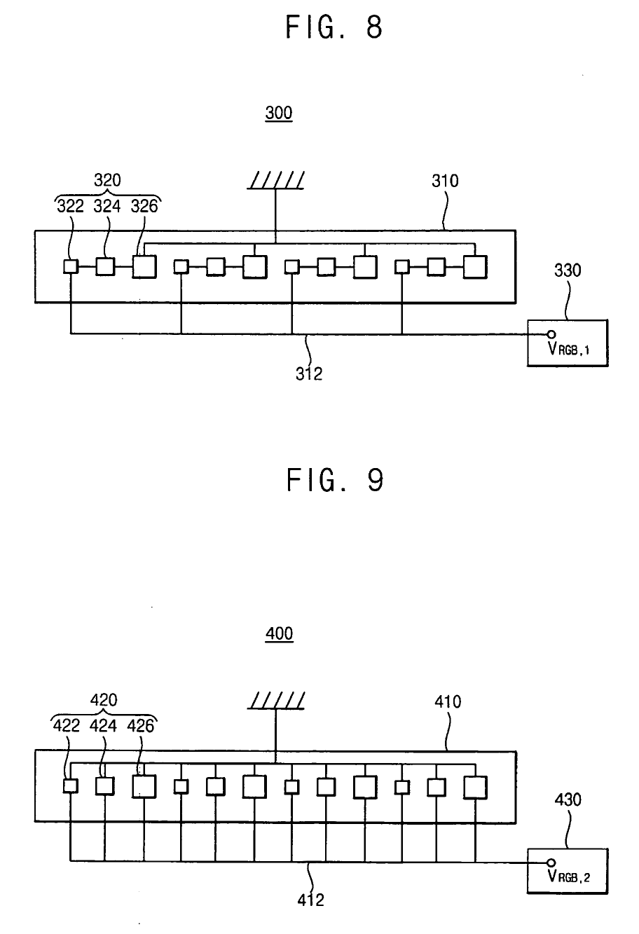

FIG. 8 is a schematic view illustrating driving the exemplary light-generating unit illustrated in FIG. 6.

Referring to FIG. 8, the red, green, and blue LEDs 322, 324 and 326 are electrically connected to a driving voltage applying line 312 formed on the circuit board 310.

A driving voltage V_{RGB,1} is applied from the power supply device 330 to the red, green, and blue LEDs 322, 324 and 326 through the driving voltage applying line 312. The red, green, and blue LEDs 322, 324 and 326 receive the driving voltage V_{RGB,1}, to thereby generate the red, green, and blue lights, respectively.

Generally, when a light-emitting area of an LED increases or decreases, a luminous intensity of light emitted from the LED also increases or decreases as a voltage applied to the LED increases or decreases. Thus, when the voltage applied to the LED is changed, substantially the same luminous intensity may be obtained by also changing the light-emitting area of the LED.

Red, green, and blue LEDs 42, 44 and 46 of the conventional light-generating unit 30 shown in FIG. 7 have substantially the same effective light-emitting areas. In contrast, the red, green, and blue LEDs 322, 324 and 326 of the light-generating unit 300 as shown in FIGS. 6 and 8 have different-sized first, second, and third effective light-emitting areas, respectively, so as to correspond to a luminous intensity ratio of the red, green, and blue lights forming a white light having a desired wavelength distribution.

Accordingly, even though only one driving voltage V_{RGB,1} is applied to the red, green, and blue LEDs 322, 324 and 326, the first, second, and third effective light-emitting areas compensate for reduced luminous intensities, to thereby obtain a desired white light.

The red, green, and blue lights emitted from the red, green, and blue LEDs 322, 324 and 326, respectively, forms a white light using a predetermined combination of the luminous intensities of the red, green, and blue LEDs 322, 324 and 326. Hence, the first, second, and third effective light-emitting areas may be determined corresponding to the luminous intensity ratio of red, green, and blue lights forming a white light having a desired wavelength distribution. Thus, sizes of the red, green, and blue LEDs 322, 324 and 326 may be determined corresponding to the first, second, and third effective light-emitting areas.

For example, in order to obtain a white light having substantially the same wavelength distribution as a predetermined wavelength distribution of a white light generated by applying driving voltages of about 2.1 V, about 3.3 V, and about 3.7 V to red, green, and blue LEDs, respectively, the first, second, and third light-emitting areas of the red, green, and blue LEDs 322, 324 and 326 may be determined as follows.

In one exemplary embodiment, the red, green, and blue LEDs 322, 324 and 326 are electrically connected to each other in series within each light source group 320, and the light source groups 320 are electrically connected to each other in parallel. Since the light source groups 320 are electrically connected to each other in parallel, substantially the same driving voltage V_{RGB,1} is applied to each of the light source groups 320. In other words, the driving voltage V_{RGB,1} is applied to a set of the red, green and blue LEDs 322, 324 and 326 electrically connected in series within one light source group 320. Substantially the same current flows in each of the red, green, and blue LEDs 322, 324 and 326 within one light source group 320. The driving voltage V_{RGB,1} is, for example, about 3.7 V.

Voltages applied to the red, green, and blue LEDs 322, 324 and 326 may be different from each other in accordance with various intrinsic properties such as material. However, when the voltages are substantially the same, the first, second and third light-emitting areas may be set to about 2.1: about 3.3: about 3.7. In other words, the light-emitting area of the red LED 322 may be smaller than the light-emitting area of the green LED 324, and the light-emitting area of the green LED 324 may be smaller than the light-emitting area of the blue LED 326. When the voltages are different from each other, such as due to the various intrinsic properties such as material, the first, second and third light-emitting areas may be adjusted to obtain a desired white light.

According to the present embodiment, the first, second and third effective light-emitting areas of the red, green, and blue LEDs 322, 324 and 326 are set different from each other, so that a white light having a desired wavelength distribution may be obtained while a same driving voltage is applied to the red, green, and blue LEDs 322, 324 and 326. Because the same driving voltage is applied to each of the LEDs 322, 324, and 326, the circuit structure for applying the driving voltage to the light source groups 320 is simplified as compared to the circuit structure of the light generating unit 30 shown in FIG. 7.

The light-generating unit 300 as shown in FIG. 8 includes the plurality of light source groups 320, and the light source groups 320 are arranged on the circuit board 310. Thus, the light-generating unit 300 may serve as a light source of a direct illumination type LCD device. However, the light-generating unit 300 is not limited to the light source of a direct illumination type LCD device, and other applications of the light-generating unit 300 are within the scope of these embodiments.

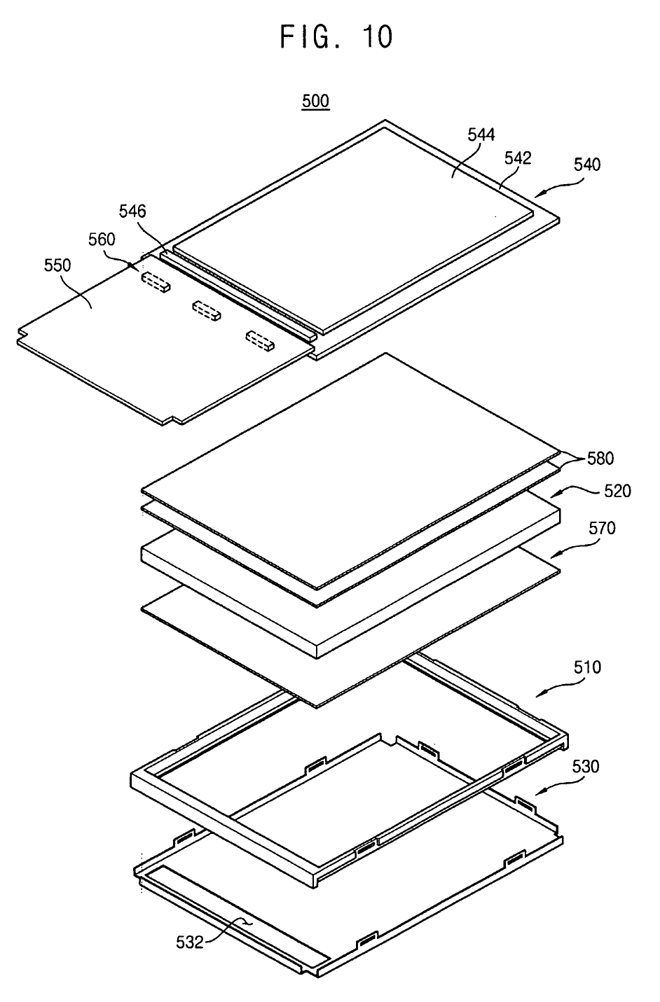

FIG. 9 is a schematic view illustrating driving an exemplary light-generating unit according to a fourth exemplary embodiment of the present invention.

Referring to FIG. 9, a light-generating unit 400 includes a light source group 420 having red, green, and blue LEDs 422, 424 and 426.

The light-generating unit 400 of the present embodiment is substantially the same as the light-generating unit 300 of FIG. 8 except for electrical connections between the red, green, and blue LEDs 422, 424 and 426 that are electrically connected in parallel. Thus, any further description will be omitted.

The red, green, and blue LEDs 422, 424 and 426 are electrically connected to a driving voltage applying line 412 formed on a circuit board 410.

A driving voltage V_{RGB,2} is applied from a power supply device 430 to the red, green, and blue LEDs 422, 424 and 426 through the driving voltage applying line 412. The red, green, and blue LEDs 422, 424 and 426 receive the driving voltage V_{RGB,2} from the power supply device, to thereby generate red, green, and blue lights, respectively.

As illustrated in FIG. 9, the red, green, and blue LEDs 422, 424 and 426 are electrically connected in parallel, and the light source groups 420 are also electrically connected in parallel. One driving voltage V_{RGB,2} is applied to the light source groups 420 electrically connected in parallel, and substantially the same driving voltage V_{RGB,2} is applied to each of the red, green, and blue LEDs 422, 424 and 426.

For example, in order to obtain a white light having substantially the same wavelength distribution as a predetermined wavelength distribution of a white light generated by applying driving voltages of about 2.1 V, about 3.3 V, and about 3.7 V to red, green, and blue LEDs, respectively, and since substantially the same voltage V_{RGB,2} is applied to each of the red, green, and blue LEDs 422, 424 and 426, first, second, and third light-emitting areas of the red, green and blue LEDs 422, 424 and 426 may be set to about 2.1: about 3.3: about 3.7, to thereby obtain a desired white light. In other words, the light-emitting area of the red LED 422 may be smaller than the light-emitting area of the green LED 424, and the light-emitting area of the green LED 424 may be smaller than the light-emitting area of the blue LED 426.

According to the exemplary embodiment of FIG. 9, the first, second, and third effective light-emitting areas of the red, green, and blue LEDs 422, 424 and 426 are set different from each other, so that a white light having a desired wavelength distribution may be obtained while one driving voltage is applied to the red, green, and blue LEDs 422, 424 and 426.

In addition, since the red, green, and blue LEDs 422, 424 and 426 of the light-generating unit 400 are electrically connected to each other in parallel, driving voltages applied to the red, green, and blue LEDs 422, 424 and 426 are substantially the same. Thus, when the effective light-emitting areas are determined, an additional adjustment of a ratio of the effective light-emitting areas may be omitted. The additional adjustment may be necessary when different driving voltages are applied to the red, green and blue LEDs 422, 424 and 426, such as to compensate for variations due to the various intrinsic properties such as material.

The light-generating unit 400 according to the exemplary embodiment of FIG. 9 includes the plurality of light source groups 420, and the light source groups 420 are arranged on the circuit board 410. Thus, the light-generating unit 400 may serve as a light source of a direct illumination type LCD device. However, the light-generating unit 400 is not limited to the light source of a direct illumination type LCD device, and alternative applications of the light-generating unit 400 are within the scope of these embodiments.

FIG. 10 is an exploded perspective view illustrating an exemplary LCD device according to a fifth exemplary embodiment of the present invention.

Referring to FIG. 10, an LCD device 500 includes a mold frame 510, a light-guiding plate 520, a receiving container 530, an LCD panel 540, a flexible circuit board 550, and a light-generating unit 560.

The mold frame 510 has, for example, a rectangular shape, a portion of which is open. The mold frame 510, for example, includes plastic.

The light-guiding plate 520 is disposed in the mold frame 510. The light-guiding plate 520 guides an optical path of light generated from the light-generating unit 560 toward the LCD panel 540.

The light-guiding plate 520 may include a transparent material so as to reduce optical loss. For example, the light-guiding plate 520 includes polymethyl methacrylate (“PMMA”) having great strength.

Alternatively, the light-guiding plate 520 may include polycarbonate (“PC”) so as to reduce a thickness of the light-guiding plate 520. Although PC has a lesser strength than that of PMMA, PC has a greater heat resistance than that of PMMA.

Reflective patterns (not shown) may be formed on a lower surface of the light-guiding plate 520 to scatter and reflect light. For example, the reflective patterns include printed patterns and/or embossed patterns. Light is incident into the light-guiding plate 520, such as into an edge of the light-guiding plate 520, from the light-generating unit 560, and the light is scattered and reflected by the reflective patterns of the light-guiding plate 520. Light in the light-guiding plate 520, which has an incident angle larger than a predetermined critical angle, exits the light-guiding plate 520 through an upper surface of the light-guiding plate 520 toward the LCD panel 540.

The receiving container 530 is coupled to the mold frame 510 to cover a lower portion of the light-guiding plate 520. For example, the receiving container 530 includes a metal that has a greater strength than that of the mold frame 510, and may be hook-combined with the mold frame 510.

An opening 532 for receiving the light-generating unit 560 is formed through the receiving container 530.

The LCD panel 540 is disposed on or over the light-guiding plate 520 to display an image using light exiting from the light-guiding plate 520.

The LCD panel 540 includes a lower substrate 542, an upper substrate 544, a liquid crystal layer (not shown) and a driver chip 546. The flexible circuit board 550 is electrically connected to the lower substrate 542. The upper substrate 544 faces the lower substrate 542. The liquid crystal layer is disposed between the lower substrate 542 and the upper substrate 544. The driver chip 546 is coupled to the lower substrate 542.

The driver chip 546 generates a driving signal that drives the LCD panel 540, in response to a control signal applied to the driver chip 546 through the flexible circuit board 550.

The LCD panel 540 may further include a first polarizing plate (not shown) formed on an outer surface of the lower substrate 542 and a second polarizing plate (not shown) formed on an outer surface of the upper substrate 544. For example, the first polarizing plate has a first polarization axis and the second polarizing plate has a second polarization axis that is substantially perpendicular to the first polarization axis.

The flexible circuit board 550 is electrically connected to a side portion of the lower substrate 542 on which the driver chip 546 is mounted. The flexible circuit board 550 is electrically connected to the lower substrate 542, for example, through an anisotropic conductive film (“ACF”).

Although not shown in FIG. 10, elements such as a capacitor and a register for generating and stabilizing the control signal are formed on the flexible circuit board 550.

Since the flexible circuit board 550 has good flexibility, the flexible circuit board 550 is bent from the LCD panel 540 to a rear surface of the receiving container 530 and is fastened to the rear surface of the receiving container 530. For example, the flexible circuit board 550 is fastened to the rear surface of the receiving container 530 using double-sided tape.

At least one light-generating unit 560 is electrically connected to the flexible circuit board 550. The light-generating unit 560 includes a circuit board, a light source group, and a housing.

The light source group and the housing are substantially the same as the light source group 120 and the housing 130 as shown in FIGS. 1 and 2. Thus, any further description will be omitted.

The circuit board of the light-generating unit 560 corresponds to a portion of the flexible circuit board 550 supporting the housing of the light-generating unit 560 thereon. A circuit structure of the circuit board of the light-generating unit 560 may be substantially the same as the circuit structure shown in FIG. 4. Alternatively, the circuit structure of the circuit board of the light-generating unit 560 may be substantially the same as the circuit structure shown in FIG. 5. Thus, any further description will be omitted.

When a portion of the flexible circuit board 550 serves as the circuit board of the light-generating unit 560, a separate circuit board for driving the light source group of the light-generating unit 560 is omitted. Thus, the LCD device 500 has a simplified structure, and manufacturing costs of the LCD device 500 may be reduced. In addition, the LCD device 500 may be advantageously smaller and lighter. Alternatively, the light-generating unit 560 may employ a separate circuit board.

A driving voltage applying line (not shown) is formed on the circuit board of the light-generating unit 560 to apply the driving voltage to the light source group. Within the light-generating unit 560, the circuit board and a power supply device (not shown) that applies the driving voltage to the light source group through the driving voltage applying line form a power supply module.

The light-generating unit 560 is disposed at a side of an incident surface of the light-guiding plate 520 by bending the flexible circuit board 550. Particularly, when the flexible circuit board 550 is bent, the light-generating unit 560 passes through the opening 532 of the receiving container 530 and is disposed adjacent to the incident surface of the light-guiding plate 520. Thus, an edge-type backlight assembly is formed for the LCD device 500.

The number of the light-generating unit 560 may be determined by a size and a desired luminance of the LCD panel 540.

The LCD device 500 optionally includes a reflective sheet 570 disposed under the light-guiding plate 520. The reflective sheet 570 reflects light leaking through a rear surface of the light-guiding plate 520 back to an interior of the light-guiding plate 520, thereby improving optical efficiency.

The LCD device 500 may further include the optical member 580 disposed on or over the light-guiding plate 520. The optical member 580 includes, for example, a light-diffusing plate and at least one optical sheet. The light-diffusing plate diffuses light exiting the light-guiding plate 520 to improve optical luminance uniformity. The optical sheet improves optical characteristics.

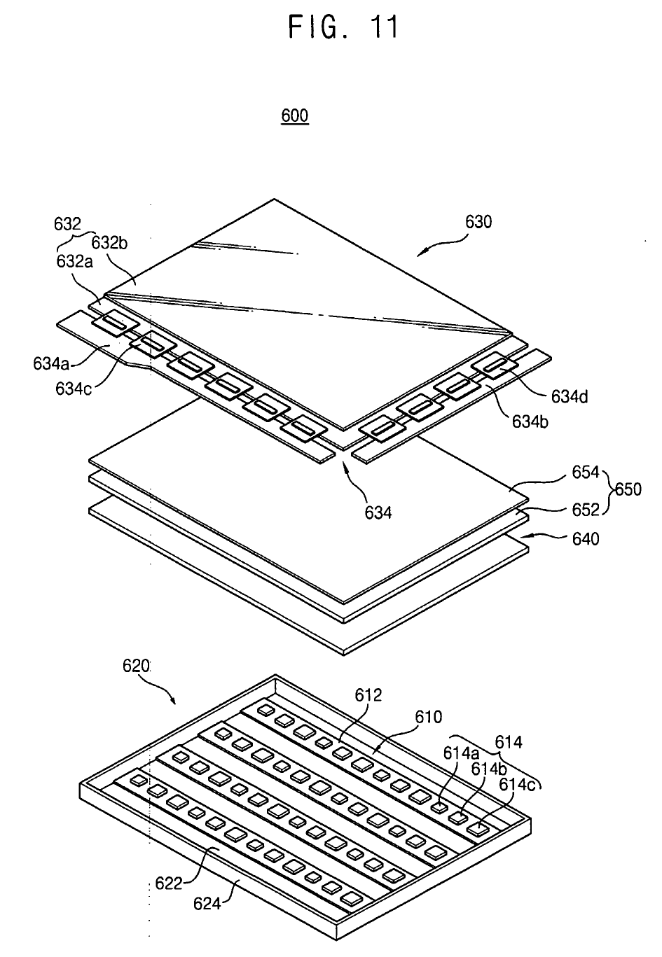

FIG. 11 is an exploded perspective view illustrating an exemplary LCD device according to a sixth exemplary embodiment of the present invention.

Referring to FIG. 11, an LCD apparatus 600 includes a plurality of light-generating units 610, a receiving container 620, and an LCD panel assembly 630.

Each of the light-generating units 610 may be substantially the same as the light-generating unit 300 shown in FIGS. 6 and 8. Thus, any further description will be omitted. Alternatively, the light-generating units 610 may be substantially the same as the light-generating unit 400 shown in FIG. 9.

The receiving container 620 receives the light-generating units 610. The receiving container 620 includes a bottom plate 622 and sidewalls 624. The sidewalls 624 are upwardly extended from edge portions of the bottom plate 622 to define a receiving space. The receiving container 620, for example, includes a metal.

The light-generating units 610 are disposed on the bottom plate 622 of the receiving container 620. The light-generating units 610 are spaced apart from each other at regular intervals, and disposed substantially in parallel with each other as shown in FIG. 11. Since the light-generating units 610 are disposed and distributed below the LCD panel assembly 630, the LCD apparatus 600 includes a direct-type backlight assembly.

Each of the light-generating units 610 may include a plurality of light source groups 614 arranged along a plurality of lines on one circuit board 612, rather than on the plurality of circuit boards 612 as shown. In either case, each of the light source groups 614 includes a red LED 614a, a green LED 614b, and a blue LED 614c. Furthermore, the circuit board or boards 612 may be disposed on an outer surface of the receiving container 620, and the light source groups 614 may be inserted into the receiving container 620, such as through openings in the bottom plate 622.

The LCD panel assembly 630 includes an LCD panel 632 and a driving circuit part 634. The LCD panel 632 displays an image using light generated from the light-generating unit 610. The driving circuit part 634 drives the LCD panel 632.

The LCD panel 632 includes a first substrate 632a, a second substrate 632b facing the first substrate 632a, and a liquid crystal layer (not shown) disposed between the first and second substrates 632a and 632b.

The LCD panel 632 includes a first polarizing plate (not shown) formed on an outer surface of the first substrate 632a and a second polarizing plate (not shown) formed on an outer surface of the second substrate 632b. For example, the first polarizing plate has a first polarization axis and the second polarizing plate has a second polarization axis that is substantially perpendicular to the first polarization axis.

The driving circuit part 634 includes a data printed circuit board (“PCB”) 634a, a gate PCB 634b, a data driving circuit film 634c and a gate driving circuit film 634d. The data PCB 634a provides the data signal to the LCD panel 632. The gate PCB 634b provides the gate signal to the LCD panel 632. The data driving circuit film 634c connects the data PCB 634a to the LCD panel 632, and the gate driving circuit film 634d connects the gate PCB 634b to the LCD panel 632.

The data driving circuit film 634c and the gate driving circuit film 634d may be formed using a tape carrier package (“TCP”) or a chip-on-film (“COF”).

The LCD apparatus 600 may further include a light-guiding member 640. The light-guiding member 640 is disposed on or over the light-generating units 610. The light-guiding member 640 is spaced apart from the light-generating units 610. The light-guiding member 640 mixes a red light, a blue light and a green light generated from the light-generating units 610 so as to generate a white light. The light-guiding member 640 includes, for example, PMMA.

The LCD apparatus 600 may further include an optical member 650 disposed on or over the light-guiding member 640. The optical member 650 may be spaced apart from the light-guiding member 640 to mix the red, blue and green lights with each other. The optical member 650 includes, for example, a light-diffusing plate 652 and at least one optical sheet 654.

The light diffusing plate 652 diffuses light that exits the light-guiding member 640 to improve optical luminance uniformity.

The optical sheet 654 is disposed on or over the light diffusing plate 652 to improve optical characteristics. The optical sheet 654 optionally includes a light-condensing sheet that condenses the diffused light by the light diffusing plate 652 so as to enhance front-view luminance. The optical sheet 654 optionally includes a light-diffusing sheet that further diffuses the diffused light by the light diffusing plate 652. The optical sheet 654 may further include various sheets to enhance desired optical characteristics.

According to the present invention, a red light source, a green light source, and a blue light source of the light-generating unit have different effective light-emitting areas from each other, thereby generating a white light having a desired wavelength distribution while one driving voltage is applied to the red, green, and blue light sources.

In addition, the light-generating unit may be packaged to serve as a light source of edge illumination type LCD device, and the light-generating unit may include a plurality of light source groups to serve as a light source of direct illumination type LCD device.

In addition, a method of driving the light-generating unit to generate white light while supplying only a same voltage to red, green, and blue light sources of the light-generating unit includes providing a red light source, a green light source, and a blue light source of the light-generating unit with different effective light-emitting areas from each other.

Although exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A light-generating unit comprising:
a light source group comprising a plurality of light sources each emitting a light of a different color from each other and each having a different effective light-emitting area from each other, so as to generate a white light including a mixture of lights emitted from the light sources; and
a power supply module applying one driving voltage to the light sources.

2. The light-generating unit of claim 1, wherein each of the light sources comprises a light-emitting diode.

3. The light-generating unit of claim 2, wherein the light-emitting diode has a chip shape.

4. The light-generating unit of claim 1, wherein the light sources comprise a red light source, a green light source, and a blue light source.

5. The light-generating unit of claim 4, wherein an effective light-emitting area of the blue light source is greater than an effective light-emitting area of the green light source, and the effective light-emitting area of the green light source is greater than an effective light-emitting area of the red light source.

6. The light-generating unit of claim 4, wherein the red light source generates a light having a wavelength of greater than or equal to about 630 nm, the green light source generates a light having a wavelength of about 500 nm to about 630 nm, and the blue light source generates a light having a wavelength of less than or equal to about 465 nm.

7. The light-generating unit of claim 1, wherein the power supply module comprises:
a circuit board having a driving voltage applying line providing the driving voltage to the light sources; and
a power supply device applying the driving voltage to the light sources through the driving voltage applying line formed on the circuit board.

8. The light-generating unit of claim 1, wherein the circuit board comprises a flexible circuit board.

9. The light-generating unit of claim 1, wherein the light sources are electrically connected in series.

10. The light-generating unit of claim 1, wherein the light sources are electrically connected in parallel.

11. The light-generating unit of claim 1, further comprising a plurality of light source groups, wherein the light sources within each light source group are connected in series and the light source groups are connected in parallel.

12. The light-generating unit of claim 1, further comprising a housing configured to receive the light sources, wherein the housing comprises:
a body having a receiving space in which the light sources are received; and
a sub-circuit board disposed in the receiving space to transmit the driving voltage from the power supply module to the light sources.

13. The light-generating unit of claim 1, wherein a ratio of the effective light-emitting areas corresponds to a luminous intensity ratio of the lights generated from the light sources.

14. A light-generating unit comprising:
a first light source emitting a first light and having a first effective light-emitting area;
a second light source emitting a second light and having a second effective light-emitting area; and
a third light source emitting a third light and having a third effective light-emitting area,
wherein the first, second and third effective light-emitting areas are different from each other such that the first, second and third lights are mixed to generate a white light.

15. The light-generating unit of claim 14, wherein the first, second, and third light sources comprise a red light-emitting diode, a green light-emitting diode, and a blue light-emitting diode, respectively.

16. The light-generating unit of claim 14, further comprising a power supply module driving the first, second, and third light sources, wherein the power supply module applies one driving voltage to the first, second, and third light sources.

17. The light-generating unit of claim 14, wherein the first, second, and third light sources are electrically connected to each other in series or in parallel.

18. The light-generating unit of claim 14, wherein a ratio of the first, second, and third effective light-emitting areas corresponds to a luminous intensity ratio of the first, second, and third lights.

19. A display device comprising:
a light-generating unit comprising:
a light source group comprising a plurality of light sources each emitting a light of a different color from each other and each having a different effective light-emitting area from each other, so as to generate a white light including a mixture of lights emitted from the light sources; and
a power supply module applying one driving voltage to the light sources; and
a display panel displaying an image using the white light generated from the light-generating unit.

20. The display device of claim 19, wherein the light sources comprise a red light-emitting diode, a green light-emitting diode, and a blue light-emitting diode.

21. The display device of claim 19, wherein the power supply module comprises:
a circuit board having a driving voltage applying line providing the driving voltage to the light sources; and
a power supply device applying the driving voltage to the light sources through the driving voltage applying line formed on the circuit board.

22. The display device of claim 21, wherein the circuit board comprises a flexible circuit board driving the display panel.

23. The display device of claim 19, wherein the light sources are electrically connected to each other in series or in parallel.

24. The display device of claim 19, wherein a ratio of the effective light-emitting areas corresponds to a luminous intensity ratio of the lights generated from the light sources.

25. The display device of claim 19, further comprising a light-guiding plate disposed at a side of the light-generating unit to guide an optical path of the white light generated from the light-generating unit to the display panel.

26. The display device of claim 19, further comprising a light-guiding member disposed on or over the light-generating unit to mix the lights generated from the light-generating unit so as to provide the white light to the display panel.

27. A display device comprising:
a light-generating unit comprising:
a first light source emitting a first light and having a first effective light-emitting area;
a second light source emitting a second light and having a second effective light-emitting area; and
a third light source emitting a third light and having a third effective light-emitting area,
wherein the first, second, and third effective light-emitting areas are different from each other such that the first, second, and third lights are mixed to generate a white light; and
a display panel displaying an image using the white light generated from the light-generating unit.

28. A method of driving a light-generating unit having a light source group including first, second, and third light sources each emitting a light of a different color from each other to generate a white light in combination, the method comprising:
supplying a first driving voltage to the first light source having a first effective light-emitting area;
supplying the first driving voltage to the second light source having a second effective light-emitting area different than the first effective light-emitting area; and,
supplying the first driving voltage to the third light source having a third effective light-emitting area different than the first and second effective light-emitting areas.

29. The method of claim 28, wherein the first, second, and third light sources are connected to each other in series or in parallel, and supplying the first driving voltage to the first, second, and third light sources is supplied substantially simultaneously.
